(19) United States
(12) Patent Application Publication
(10) Pub. No.: US 2011/0135236 A1
(43) Pub. Date: Jun. 9, 2011

(54) Reusable bearing and reuse method thereof

(75) Inventors: Takashi Yamamoto, Kuwana-shi (JP); Seiichi Takada, Kuwana-shi (JP)

(73) Assignee: NTN CORPORATION, Osaka (JP)

(21) Appl. No.: 12/929,593

(22) Filed: Feb. 2, 2011

Related U.S. Application Data
(63) Continuation of application No. PCT/JP2009/003572, filed on Jul. 29, 2009.

(30) Foreign Application Priority Data
Aug. 6, 2008 (JP) 2008-203102

(51) Int. Cl. F16C 19/24; F16C 33/46; B23P 6/00

(52) U.S. Cl. 384/548; 384/572; 29/402.01

(57) ABSTRACT

A reusable bearing that can be easily reused without accompanying any problem associated with reduction in performance is provided. The reusable bearing (1) is a rolling bearing for use in an office machine, which is available for reuse in an office machine under a load lower than the fatigue limit load after it has been used under the load lower than the fatigue limit load and subsequently collected.

### CROSS REFERENCE TO THE RELATED APPLICATION

This application is a continuation application, under 35 U.S.C. §111(a), of international application No. PCT/JP2009/003572, filed Jul. 29, 2009, which claims priority to Japanese patent application No. 2008-203102, filed Aug. 6, 2008, the entire disclosure of which is herein incorporated by reference as a part of this application.

### BACKGROUND OF THE INVENTION

1. Field of the Invention

The present invention relates to a reusable bearing for use in office machines and equipments such as, for example, a copying machine and a printer and a method of reusing such reusable bearing.

2. Description of the Related Art

Various statutory provisions have been stipulated for facilitating effective utilization of resources and, even in the field of office machines and equipments including, for example, copying machines and printers, reuse of component parts thereof have been desired for. In those office machines and equipments, a number of bearings have been employed in, for example, a paper feed mechanism and developing and photosensitive mechanisms and, in particular, rolling bearings have been utilized for the orientation of high precision. As far as copying machines are concerned, the social infrastructure has been established, in which most component parts of the copying machines, which have been called in and subsequently disassembled, are effectively recycled and/or reused. Under these circumstances, the bearings employed in the copying machines are merely reused as a material for steel materials.

As far as the rolling bearings employed in the field other than that referred to above, various suggestions have been made in some quarters to reuse component parts of, for example, retainers (such as addressed in the Patent Document 1 listed below) and to remove surface layers of the raceway surfaces and subsequently treat to form a hardened layer for reuse purpose (such as addressed in the Patent Document 2 listed below).

[Patent Document 1] JP Laid-open Patent Publication No. 2005-331046

[Patent Document 2] JP Laid-open Patent Publication No. 2007-120632

### SUMMARY OF THE INVENTION

As discussed above, the social infrastructure for collection of copying machines for reuse purpose has already been consolidate and the bearings so collected are too many. For this reason, reuse of those bearings is desired for. However, the bearings are generally considered as mechanical component parts technically difficult to be reused from the standpoint of the high precision that is to be maintained and, therefore, reusable bearing has not yet been made available.

Also, as far as the office machines and equipments are concerned, the demands for reduction in cost is so keen that stringent reduction in cost of bearings, which are component parts used in those office machines and equipments, may be essential, and, therefore, removal of the surface layers and subsequent treatment to form the hardened layers such as suggested in the Patent Documents 2 listed above tends to lead to an increased cost enough to make it impossible to realize. In addition, mere reuse of only some of those components such as, for example, retainers is remotely far from achieving the intended object as reusable bearings.

An object of the present invention is to provide a reusable bearing that can be easily reused without accompanying any problem associated with reduction in performance.

Another important object of the present invention is to provide a method of reuse of the bearing that enables the latter to be easily reused without accompanying any problem associated with reduction in performance.

A reusable bearing according to the present invention is a rolling bearing for use in an office machine, which is available for reuse in an office machine under a load lower than a fatigue limit load of the rolling bearing after it has been used under a load lower than the fatigue limit load and subsequently collected.

The fatigue limit is a limit value that is exhibited when no breakdown occur even though stresses of a magnitude lower than the limit value have been applied infinitely repeatedly. The fatigue limit load stands for an external force that is applied when the fatigue limit referred to above is exhibited. Where the bearing is used under a load lower than the fatigue limit load, it can be used for infinite hours from the standpoint of the fatigue. Accordingly, even though the bearing used under the load lower than the fatigue load limit is reused after having been collected, no problem associated with the fatigue lifetime will occur. When the reuse of the bearing is carried out under the load lower than the fatigue limit load, the reliability will become further high. Therefore, if the bearing collected after it has been used under the load lower than the fatigue limit load is reused under the load lower than the fatigue limit load, the reuse can be accomplished with high reliability without accompanying any problem associated with the fatigue lifetime.

Most of the rolling bearings employed in the paper feed mechanism and the developing and photosensitive mechanisms of the copying machine or the printer are used under a very light applied load at which a surface pressure is little loaded on the raceway surfaces. For this reason, most of the bearings employed in the office machine such as, for example, the copying machine are used under a load lower than the fatigue limit load and, hence, they can be reused.

The reusable bearing of the present invention may be a rolling bearing of a lubricant filled type, in which case a lubricant is refilled in the bearing after the latter has been collected, but before the latter is reused. The lubricant referred to above is, for example, grease.

In the case of the rolling bearing of the lubricant filled type, even though it is used under a load lower than the fatigue limit load, a problem associated with the lubrication lifetime tends to arise as a result of the service life of the filled lubricant. For this reason, in the case of the rolling bearing of the lubricant filled type, the necessity tends to occur that the lubricant need be refilled.

The reusable bearing according to the present invention may be a rolling bearing comprising an inner ring, an outer ring, rolling elements and a retainer, in which case the inner ring, the outer ring and the rolling elements make use of reusable component parts and the retainer makes use of a new and fresh component part.

The retainer is susceptible to a problem associated with frictional wear that is brought about as a result of sliding contact with, for example, the rolling elements. For this reason, as regards the retainer, it is necessary to be replaced with the new and fresh component part, when it is to be reused, so that the accuracy of rotation can be maintained.

The reusable bearing according to the present invention may be a rolling bearing comprising an inner ring, an outer ring, rolling elements, a retainer and a sealing member or a sealing plate, in which case the inner ring, the outer ring and the rolling elements make use of reusable component parts and the sealing member or the sealing plate is made of a rubber material or a resinous material and makes use of a new and fresh component part. As regards the retainer, it may be either a new and fresh component part or a reusable component part.

The sealing member made of a rubber material or a resinous material is susceptible to frictional wear and/or degradation of material as a result of sliding contact with a rotatable ring and has therefore a short lifetime as compared with that of any of the bearing forming component parts that are made of a steel material. For this reason, it is desirable for the sealing member to be replaced with a new and fresh component part in order to maintain the sealability.

A method of reusing a bearing according to the present invention includes steps of collecting the bearing after the latter has been used in an office machine under a load lower than a fatigue limit load of the bearing and reusing the collected bearing for another office machine under a load lower than the fatigue limit load.

As discussed hereinbefore in connection with the reusable bearing of the present invention, when the bearing used in an office machine under the load lower than the fatigue limit load is collected and is subsequently reused in another office machine under the load lower than the fatigue limit load, the reuse can be accomplished with high reliability without accompanying any problem associated with the fatigue lifetime.

In the practice of the method of the present invention, the method may includes steps of applying respective identification numbers to bearings and monitoring respective conditions of use of those bearings by means of a computer, whereby one or more of those bearings, in which the respective conditions of use have attained a predetermined condition, can be reused.

In the rolling bearings of a kind employed in the office machine, most of them are used under a load lower than the fatigue limit load. Of course, there are some of the bearings that are used under a load exceeding the fatigue limit load. Accordingly, if respective identification numbers are marked on the bearings and, using the computer, respective conditions of use of those bearings are monitored so that only one or more of those bearings, the condition of use of which has attained the predetermined condition can be reused, any possible erroneous reuse of the bearings under the load exceeding the fatigue limit load can be avoided.

In the practice of the method of the present invention, the bearing may be of a lubricant filled type, in which case grease is refilled after the bearing has been collected, but before it is reused.

Also, in the practice of the method of the present invention, the bearing may be of a type including an inner ring, an outer ring, rolling elements and a retainer, in which case the inner ring, the outer ring and the rolling elements in the reused bearing are those in the collected bearing while the retainer in the reused bearing is a replaced one.

Yet, in the practice of the method of the present invention, the bearing may be a rolling bearing comprising an inner ring, an outer ring, rolling elements, a retainer and a sealing member or a shielding plate, in which case the inner ring, the outer ring and the rolling elements in the reused bearing are those in the collected bearing while the sealing member or the shielding plate is a replaced one. In such case, as regards the retainer, it may be replaced with either a new and fresh component part or a reusable component part.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a sectional view showing a reusable bearing according to a preferred embodiment of the present invention;

FIG. 2 is a flowchart showing a method of using the reusable bearing in FIG. 1; and

FIG. 3 is an explanatory diagram descriptive of the reusing method, shown together with a front elevational view of the reusable bearing in FIG. 1 and a computer.

### DETAILED DESCRIPTION OF THE PREFERRED EMBODIMENTS

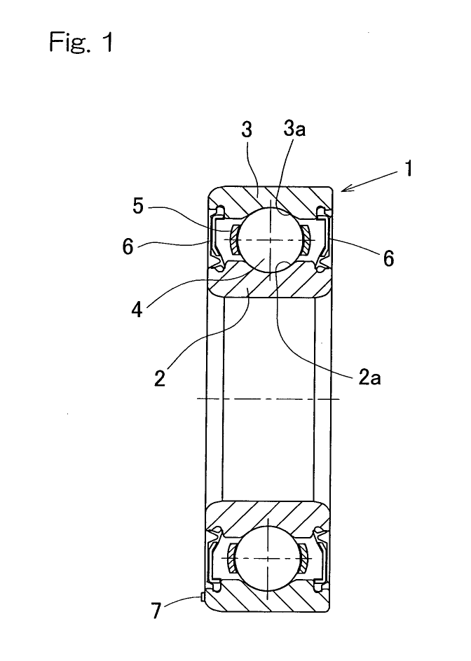

A reusable bearing according to a preferred embodiment of the present invention and a method of reusing it will be described in detail with reference to the accompanying drawings, particularly FIGS. 1 to 3. The reusable bearing 1 shown therein is a rolling bearing in the form of a deep groove ball bearing and is used in an office machine such as, for example, a copying machine or a printer. By way of example, it can be used as a supporting bearing for a support shaft supporting one or more rollers employed in a paper feed mechanism and developing and photosensitive mechanism in the office machine referred to above. This reusable bearing 1 is in the form of a rolling bearing of a lubricant filled type and is of a type in which a plurality of rolling elements 4 retained by a retainer 5 are interposed between raceway surfaces 2a and 3b defined respectively in an inner ring 2 and an outer ring 3 in face-to-face relation with each other. For the lubricant filled therein, grease, for example, is employed. The retainer 5 has pockets defined therein at a plurality of circumferential locations, with each of the rolling elements 4 retained within such pocket. The rolling elements are in the form of balls made of a steel material or a ceramic material. The retainer 5 is made of a resinous material or a metallic material. The inner ring 2 and the outer ring 3 are made of a steel material such as, for example a bearing steel. Opposite ends of a bearing space delimited between the inner and outer rings 2 and 3 are sealed by respective sealing members 6. Each of the sealing members 6 is engaged in and hence mounted inside a seal catch groove defined in an inner peripheral surface of the outer ring 3, so that the sealing member 6 slidingly contact with an outer peripheral surface of the inner ring 2. Each of those sealing members 6 may be in the form of a contact sealing member or a non-contact type shielding plate, but for the purpose of reuse, it is desirable to use a rubber material or a resinous material so that the respective sealing member 6 can be readily removed. It is, however, to be noted that the sealing members 6 may be dispensed with.

As shown in FIG. 3, the reusable bearing 1 according to the present invention has a marking 7 descriptive of an identification number inscribed or otherwise embossed in a side face of one of the outer and inner rings 3 and 2. The identification number referred to above represents, for example, a serial number allocated to the reusable bearing 1 and differs from bearing to bearing.

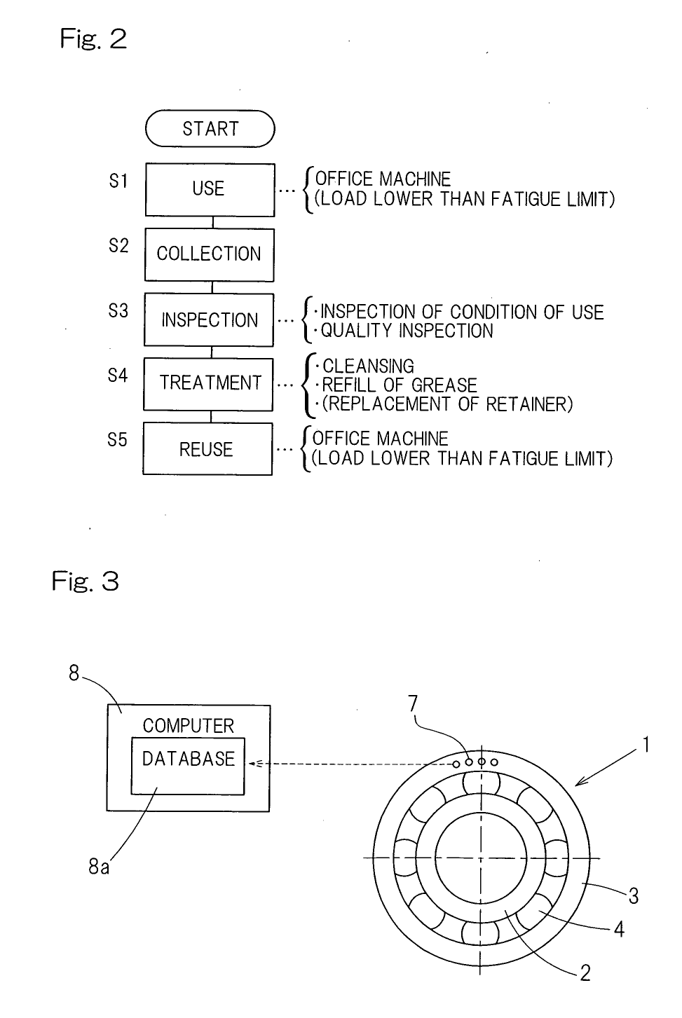

As shown in the flowchart of FIG. 2, the reusable bearing 1 of the construction described above is of a type that has been used in an office machine such as, for example, a copying machine or a printer under a load lower than or equal to the fatigue limit load (at step S1), is then collected (at step S2) and is reused in another office machine under a load lower than or equal to the fatigue limit load (at step S5) after having been inspected (at step S3) and subsequently treated in a predetermined process (at step S4).

The fatigue limit load stands for an external force that is applied when the fatigue limit is exhibited. The fatigue limit is a limit value that is exhibited when no breakdown occur even though stresses of a magnitude lower than the limit value have been applied infinitely repeatedly.

In the case of the rolling bearing, the fatigue limit load is prescribed in JIS (JIS 1518) or the ISO standards (ISO 281:2007), and the fatigue limit load Cu is presumed as a load applied when the fatigue limit stress θu is attained in the maximum loaded contact region. In calculating the fatigue limit load Cu, the following influential factors, that is, “the type of the bearing, the size of the bearing and the internal geometric configuration of the bearing, respective shapes of the rolling elements and the raceway surfaces, the quality of the manufactured product, the fatigue limit of a raceway ring material” are taken into consideration.

In the case of a ball bearing and a roller bearing, as a simplified computation, the following formulae (1) to (4) can be employed in presuming the fatigue limit load Cu. As the “fatigue limit load” referred to in the claims attached hereto, a presumed value calculated according to this simplified computation may be employed.

It is to be noted that Dpw represents the diameter of the pitch circle depicted by the rolling element and Co represents the basic static load rating.

Ball Bearing

In the case of Dpw≦100 mm: Cu=Co/22 (1)

In the case of Dpw>100 mm: Cu=Co/22(100/Dpw)^{0.5} (2)

Roller Bearing

In the case of Dpw≦100 mm: Cu=Co/8.2 (3)

In the case of Dpw>100 mm: Cu=Co/8.2(100/Dpw)^{0.3} (4)

During the reuse (step S5), the same site in the same type of the office machine as those during the initial use (step S1) is employed. In other words, the bearing used to support a paper feed roller in a copying machine during the initial use (step S1) is used to support the paper feed roller in another copying machine even during the reuse. The inspection (step S3) and the treatment (step S4) may be reversed in order relative to each other and/or the inspection (step S3) may be performed separately before and after the treatment (step S4) depending on the particulars to be inspected.

The inspection (step S3) referred to above includes a quality inspection and a determination of whether or not the bearing has been used under the load lower than the fatigue limit load during the use (step S1).

The determination of whether or not the bearing has been used under the load lower than the fatigue limit load is carried out in the following manner. By way of example, using the identification number 7, the condition of use of the individual bearing 1 during the use (step S1) is monitored and stored in a database 8a within the computer 8. By comparing the identification number of the collected bearing 1 with the stored numbers, whether or not the bearing has been used under the load lower than the fatigue limit load is determined from the condition of use so obtained from the database 8a. The information on the condition of use referred to above, which is stored in the database 8a may be, for example, either information concerning the type of the office machine and the site of use in such office machine or information concerning a load condition under which the office machine is used. Also, whether or not the condition of use under the load lower than the fatigue limit load is met may be determined from, for example, the type of the office machine and the site of use prior to inputting the condition to the database 8a, and a result of such determination may then be stored in the database 8a as the condition of use.

The quality inspection referred to above may include an inspection to determine the presence or absence of flaws such as, for example, an acoustic inspection and/or a visual inspection with naked eyes.

The treatment (step S4) referred to above includes, for example, cleansing, refilling of grease and replacement of a required component part with a new and fresh component part. The cleansing is carried out in a manner with the bearing 1 disassembled and reassemblage may be carried out after the cleaning. A component part to be replaced includes, for example, the retainer 5 and/or the sealing member 6. Both of the retainer 5 and the sealing member 6 may be replaced or only one of the retainer 5 and the sealing member 6 may be replaced. Without the replacement of the component part being carried out, the bearing 1 may be reused (at step S5).

According to the reusable bearing 1 and the reusing method, the bearing 1, which has been used in an office machine under the load lower than the fatigue limit load, is collected and is reused in an office machine under the load lower than the fatigue limit load. Because of this, with no problem of the fatigue lifetime being accompanied, the reuse can be accomplished with high reliability.

Most of the rolling bearings employed in the paper feed mechanism and the developing and photosensitive mechanisms of the copying machine or the printer are used under a very light applied load at which a surface pressure is little loaded on the raceway surfaces. For this reason, most of the bearings employed in the office machine such as, for example, the copying machine are used under a load lower than the fatigue limit load and, hence, they can be reused.

Also, after the collection, grease is refilled prior to the reuse and, therefore, the lubrication lifetime can be reset to an initial state

Where the retainer 5 is to be replaced with a new and fresh retainer after the collection, even though frictional wear occurs in the collected bearing 1 as a result of sliding contact between the rolling elements 4 and the retainer 5, it can be restored to an initial condition and the rotational accuracy can be maintained.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1: Reusable bearing

2: Inner ring

3: Outer ring

4: Rolling element

5: Retainer

6: Sealing member

7: Marking descriptive of the identification number

8: Computer

What is claimed is:

1. A reusable bearing comprising a rolling bearing for use in an office machine, the rolling bearing being available for reuse in an office machine under a load lower than a fatigue limit load after the rolling bearing has been used under a load lower than the fatigue limit load and subsequently collected.

2. The reusable bearing as claimed in claim 1, wherein the rolling bearing is of a lubricant filled type and a lubricant is refilled in the rolling bearing after the rolling bearing has been collected, but before the bearing is reused.

3. The reusable bearing as claimed in claim 1, wherein the rolling bearing includes an inner ring, an outer ring, rolling elements and a retainer, and the inner ring, the outer ring and the rolling elements make use of reusable component parts and the retainer makes use of a new and fresh component part.

4. The reusable bearing as claimed in claim 1, wherein the rolling bearing includes an inner ring, an outer ring, rolling elements, a retainer and a sealing member or a sealing plate, and the inner ring, the outer ring and the rolling elements make use of reusable component parts and the sealing member or the sealing plate is made of a rubber material or a resinous material and makes use of a new and fresh component part.

5. A method of reusing a bearing employed in an office machine, comprising steps of collecting the bearing after the bearing has been used in an office machine under a load lower than a fatigue limit load and reusing the collected bearing for an office machine under a load lower than the fatigue limit load.

6. The method of reusing the bearing as claimed in claim 5, further comprising steps of applying respective identification numbers to bearings and monitoring respective conditions of use of those bearings by a computer, whereby one or more of those bearings, in which the respective conditions of use have attained a predetermined condition, can be reused.

7. The method of reusing the bearing as claimed in claim 5, wherein the bearing is of a grease filled type and grease is refilled in the bearing after the bearing has been collected, but before the bearing is reused.

8. The method of reusing the bearing as claimed in claim 5, wherein the rolling bearing includes an inner ring, an outer ring, rolling elements and a retainer, and the inner ring, the outer ring and the rolling elements make use of reusable component parts and the retainer makes use of a new and fresh component part.

9. The method of reusing the bearing as claimed in claim 5, wherein the rolling bearing includes an inner ring, an outer ring, rolling elements, a retainer and a sealing member or a sealing plate, and the inner ring, the outer ring and the rolling elements make use of reusable component parts and the sealing member or the shielding plate is made of a rubber material or a resinous material and makes use of a new and fresh component part.
